(19) United States
(12) Patent Application Publication
(10) Pub. No.: US 2025/0074171 A1
(43) Pub. Date: Mar. 6, 2025

(54) VEHICLE ROOF MODULE FOR A SENSOR

(71) Applicants: Thomas Anton Martijnszoon Albers, Venray (NL); Marcel Johan Christiaan Nellen, Merselo (NL); Ruud Geurts, Helden (NL); Marcel Klefisch, Mönchengladbach (DE)

(72) Inventors: Thomas Anton Martijnszoon Albers, Venray (NL); Marcel Johan Christiaan Nellen, Merselo (NL); Ruud Geurts, Helden (NL); Marcel Klefisch, Mönchengladbach (DE)

(21) Appl. No.: 18/817,722

(22) Filed: Aug. 28, 2024

(30) Foreign Application Priority Data
Aug. 29, 2023 (EP) 23194071.9

(51) Int. Cl. B60J 7/057; B60S 1/48; B60S 1/52; B60S 1/56; E05D 15/44; E05F 15/71

(52) U.S. Cl. CPC B60J 7/0573; B60S 1/485; B60S 1/522; B60S 1/56; E05D 15/44; E05F 15/71; E05Y 2900/542

(57) ABSTRACT

The invention relates to a vehicle roof module for a sensor, configured to be mounted on a roof of a vehicle. The roof module including a roof skin having an opening and defining an exterior side and an interior side of the roof module. Further including a sensor mounting location, arranged at the interior side, having a visor providing a field of view through the opening; a cover panel movable along a sliding path; and a kinematic mechanism for moving the cover panel along the sliding path between: a closed position wherein the cover panel covers the opening and blocks the field of view of the visor and a retracted position wherein the cover panel uncovers the opening and clears the field of view of the visor.

### CROSS-REFERENCE TO RELATED APPLICATION

The present application is based on and claims the benefit of European patent application Serial No. 23194071.9, filed Aug. 29, 2023, the content of which is hereby incorporated by reference in its entirety.

### FIELD

The present invention relates to a vehicle roof module and in particular to a vehicle roof module for a sensor that is to be mounted on top of a vehicle roof.

### BACKGROUND

In support of driving assistance for vehicles and for the further aim of supporting autonomous driving of vehicles, sensors for image recognition, for example of road and traffic signs, are being mounted on such vehicles. Thereto, the sensor may be placed within a housing on top of a roof of a vehicle to provide a wide field of view. The housing may be part of a vehicle roof module and may also be referred to as an exterior sensor module. The housing or roof module will have a front screen or visor to provide a light sensitive sensor, such as a LiDAR sensor, with an unobstructed field of view. As with any other exterior part of a vehicle, the module will be exposed to weather and environmental conditions. And it may further be prone to damage.

### SUMMARY

In order to ensure proper operation over time, there is a need to provide a roof module that may withstand the above-mentioned conditions. It is an object of the invention to alleviate the impact of the abovementioned risks.

According to the invention, this object is achieved by providing a vehicle roof module for a sensor, configured to be mounted on a roof of a vehicle.

According to one aspect, a roof module is provided including a roof skin having an opening and defining an exterior side and an interior side of the roof module. The roof module further including a sensor mounting location, arranged at the interior side, having a visor providing a field of view through the opening; a cover panel movable along a sliding path. And a kinematic mechanism for moving the cover panel along the sliding path between a closed position wherein the cover panel covers the opening and blocks the field of view of the visor, and a retracted position wherein the cover panel uncovers the opening and clears the field of view of the visor.

According to another aspect, the cover panel of the roof module is movable into at least one intermediate position, the at least one intermediate position being along the sliding path between the retracted position and the closed position. And wherein the at least one intermediate position maintains, at least partially, the field of view for the visor.

According to yet another aspect, the roof module is provided with a kinematic mechanism having a sliding assembly.

According to a further aspect, the roof module is provided with a kinematic mechanism having a lifting assembly.

According to yet a further aspect, the roof module is provided with a NVH detection unit/means for detection of Noise, Vibration, and/or Harshness.

Particular embodiments of the invention are set forth in the dependent claims.

Further objects, aspects, effects and details of particular embodiments of the invention are described in the following detailed description of a number of exemplary embodiments, with reference to the drawings.

### BRIEF DESCRIPTION OF THE DRAWINGS

By way of example only, the embodiments of the present disclosure will be described with reference to the accompanying drawings, wherein:

FIG. 1 illustrates a perspective view of an example of vehicle roof and a roof module;

FIGS. 2A and 2B illustrate an example of a vehicle roof module in different states in accordance with the invention;

FIG. 3 shows a cross section of an example of a roof module in accordance with the invention.

FIG. 4 illustrates an exploded view of components making up the roof module of FIG. 3;

FIGS. 5A and 5B illustrate an example of a kinematic mechanism of the roof module of FIG. 3 in a closed position and a retracted position;

FIGS. 6A-6C illustrate the kinematic movement of the roof module of FIG. 3;

FIGS. 7A and 7B illustrate another example of an embodiment of a vehicle roof module in different states in accordance with the invention;

FIG. 8 illustrates an exploded view of components making up the roof module of FIG. 7B;

FIGS. 9A-9C illustrate the kinematic movement of the roof module of FIG. 8; and

FIG. 10 illustrates yet another example of an embodiment of a vehicle roof module in accordance with the invention.

### DETAILED DESCRIPTION OF ILLUSTRATIVE EMBODIMENTS

In the following description spatial references as, for example, front, side and rear, or underneath, below and above, or forward and rearward direction, are made with regard to the general orientation of a vehicle, such as a passenger car. And in particular to a driver behind a steering wheel of such as vehicle.

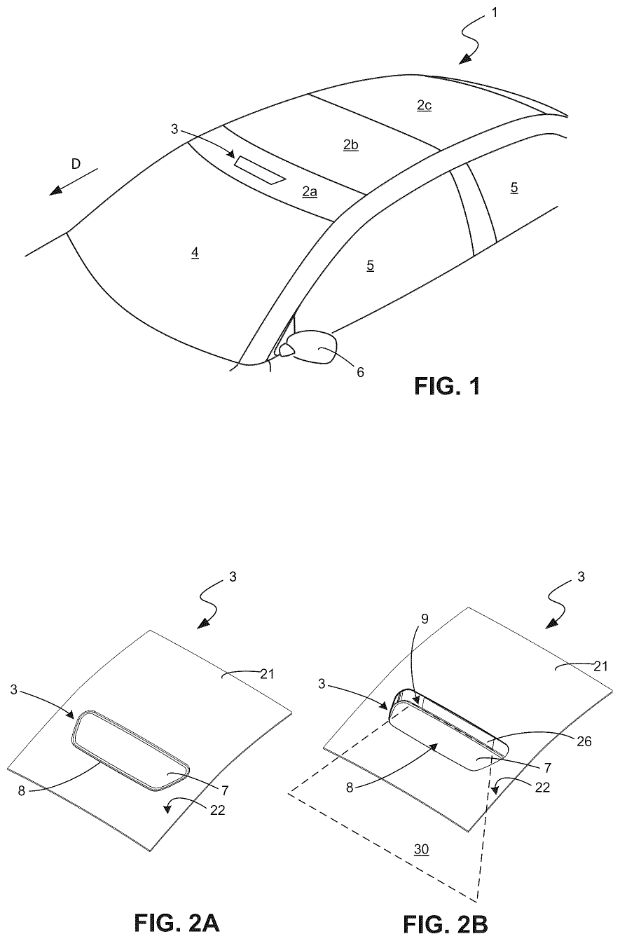

Referring to FIG. 1, a perspective view of an example of a vehicle is schematically illustrated. The vehicle is oriented with a forward direction of driving as indicated by arrow D. The vehicle 1 includes a roof 2, in this example consisting of several roof panels 2a, 2b, 2c. One or more of the roof panels 2a-c may be part of an open roof assembly. A vehicle roof module 3 for a sensor is mounted on one of the roof panels, and in this embodiment integrated with a first or forward panel 2a of the vehicle roof. The vehicle roof module 3 is illustrated as integrated in roof panel 2a, which roof panel 2a in some embodiments may be considered part of the roof module. Further shown are vehicle front window 4, side windows 5 and side mirror 6. The vehicle roof module 3 on top of the roof may also be referred to as an external sensor module.

Referring to FIGS. 2A and 2B, the vehicle roof module 3 is illustrated as a separate component 3. The roof module 3 includes a roof skin 21 having an opening 8. The roof skin defines an exterior side 22 and an interior side 23 of the roof module 3. The roof module 3 further includes a sensor mounting location 25, arranged at the interior side 23, that includes a visor 26. The visor 26 provides a field of view 30 through the opening 8. The roof module 3 further includes a cover panel 7 having dimensions that correspond to the opening 8 in the roof skin 21 of the roof panel 2a. More in particular, the opening 8 has an inner perimeter and the cover panel 7 has an outer perimeter corresponding to the inner perimeter of the opening 8. The cover panel 7 is movable between a closed position in FIG. 2A and a retracted position in FIG. 2B. In the closed position shown in FIG. 2A, the cover panel 7 covers i.e. closes off the opening 8 in the roof panel 2a and blocks the field of view 30. In the retracted position shown in FIG. 2B, the cover panel 7 uncovers the opening 8 and clears the field of view 30 of the visor 26. In this embodiment, the cover panel 7 in the retracted position may reside beneath the roof skin and/or front panel 2a. In the retracted position, the cover panel 7 uncovers the opening 8 and exposes an inner recess 9 of the roof module 3. Therewith it clears the field of view 30 for a sensor that may be mounted at the sensor mounting location 25, or at least provides a clear field of view through the visor 26 to the exterior side 22. The sensor may be a LiDAR sensor, or any other optical sensor.

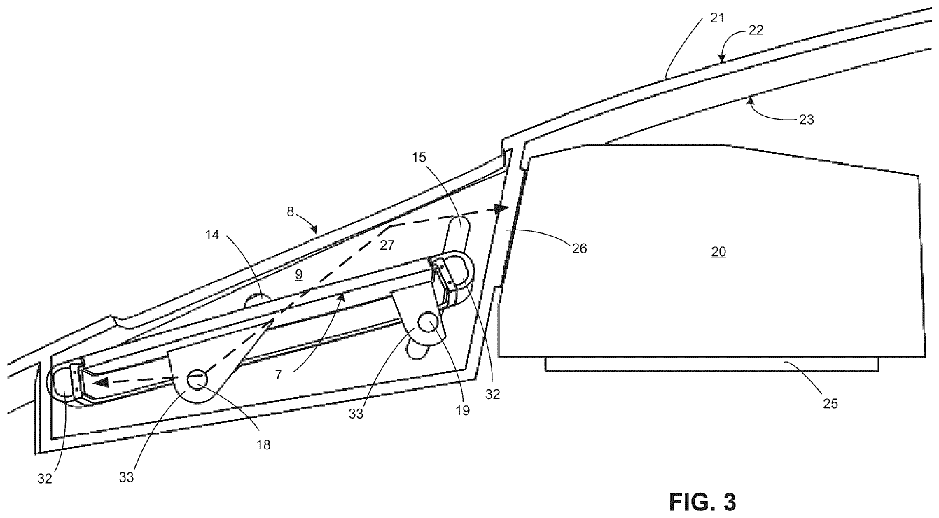

Referring to FIG. 3, the vehicle roof module 3 shown in cross section illustrates more detail of the module. It further shows the roof skin 21 defining the exterior side 22 and the interior side 23 in relation to the opening 8. The roof module 3 further includes the inner recess 9 adjacent the opening 8 on the interior side 23 of the roof skin 21. And the sensor mounting location 25 arranged at the interior side 23 of the roof module 3, separated from the inner recess 9 by the visor 26. The sensor mounting location 25 may be provided as a frame and equipped with bolting holes or other means for securing the sensor. As mentioned, the cover panel 7 is movable between the retracted position wherein, in this embodiment, the cover panel 7 resides within the inner recess 9 and the closed position wherein the cover panel 7 covers the opening 8. In the closed position, the cover panel 7 may be substantially flush with the roof skin 21. When moved between the retracted position and the closed position, the cover panel 7 travels along a virtual sliding path 27, indicated by a dotted line.

The cover panel 7 further is provided with a bump seal 32 running along the outer perimeter thereof. The cover panel 7 further includes support flanges 33 whereon sliding pins 18, 19 are provided.

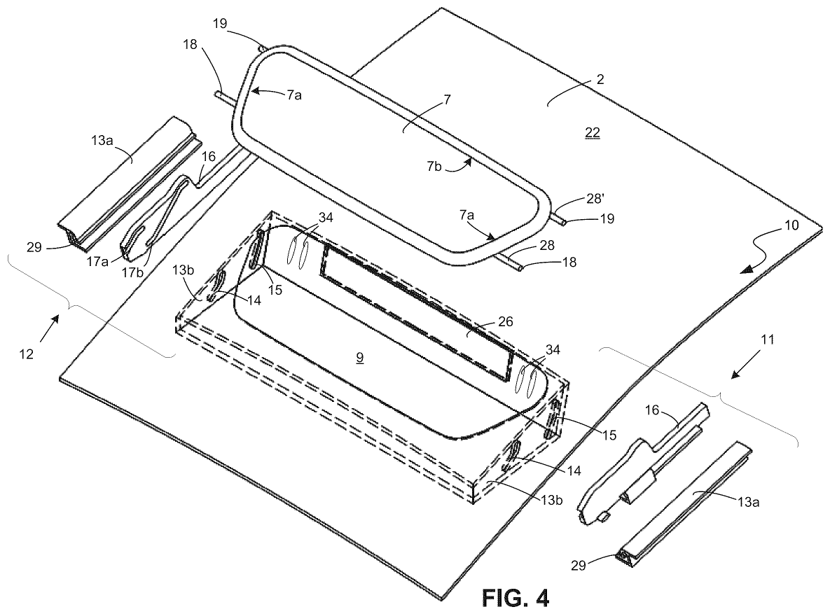

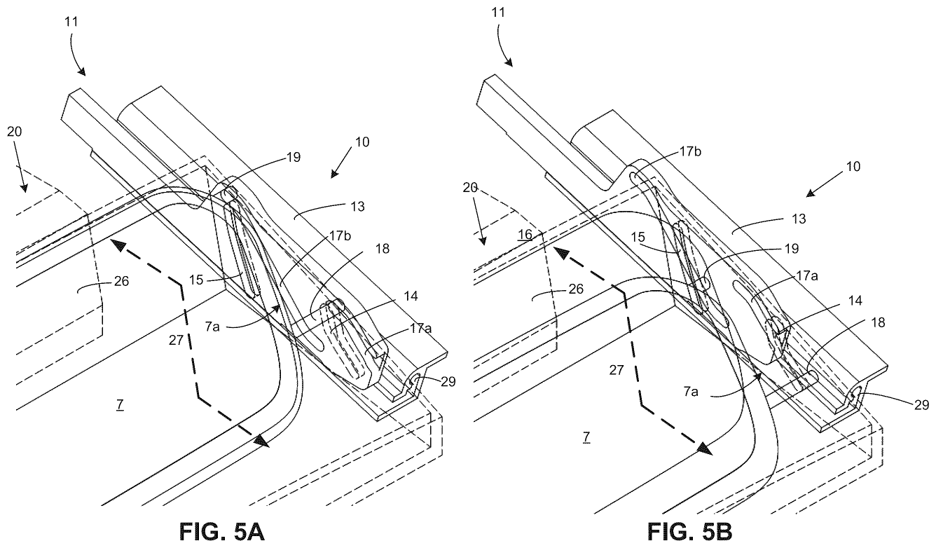

Further referring to FIG. 4, illustrating an exploded view of the roof module 3 with the cover panel 7 partially transparent for illustrative purposes, the cover panel 7 is shown to include at each of two respective opposite edges 7a at least one sliding pin respectively. In this embodiment a front sliding pin 18 and a rear sliding pin 19 on each of the two opposite edges 7a. The roof module 3 further includes a kinematic mechanism 10. The kinematic mechanism 10 consists of two sliding assemblies 11, 12 arranged in parallel at opposing sides of the inner recess 9, which inner recess is adjacent the opening 8. In between the sliding assemblies 11, 12 the cover panel 7 is located, hence the sliding assemblies 11, 12 are spaced apart to accommodate the movement of the cover panel 7 there between. The cover panel 7 faces each sliding assembly 11, 12 with a respective side edge 7a, see also FIGS. 5A-B. Each sliding assembly 11, 12 consists of a guide 13 having at least one locator curve, in this embodiment a first, front locator curve 14 and a second, rear locator curve 15. Each guide 13 further includes a slider channel 29. In this embodiment, each guide 13 is shown as consisting of a rail portion 13a and a wall portion 13b. Each sliding assembly 11, 12 further includes a driven slider 16 having at least one sliding track, in this embodiment a front sliding track 17a and a rear sliding track 17b. The slider channels 29 are for guiding each of the driven sliders 16 parallel to the opposing sides of the recess 9. The cover panel 7 is provided on each side edge 7a facing a respective sliding assembly 11, 12 with a first, front sliding pin 18 and a second, rear sliding pin 19. Two pins at respective opposite edges 7a of the cover panel 7 may be formed by outer portion ends of a single rod. In this example two front pins 18 are formed by rod 28. Likewise, two rear pins 19 may be formed by outer portion ends of a single rod 28′.

Referring to FIGS. 5A and 5B, the roof module of FIG. 4 with sliding assembly 11 is shown in more detail. In FIG. 5A the kinematic mechanism 10 is illustrated with the cover panel 7 in the closed position, and FIG. 5B illustrates the kinematic mechanism 10 with the cover panel 7 in the retracted position. The at least one locator curve of the guide 13, in this embodiment a front locator curve 14 and a rear locator curve 15, and the at least one sliding track 17b are arranged for guiding the respective at least one sliding pin 18, 19, such that the cover panel 7 moves along the sliding path 27. When the cover panel 7 is moved from the closed position to the retracted position, the visor 26 and the sensor 20 positioned there behind will be provided with a clear field of view to the exterior side of the roof module.

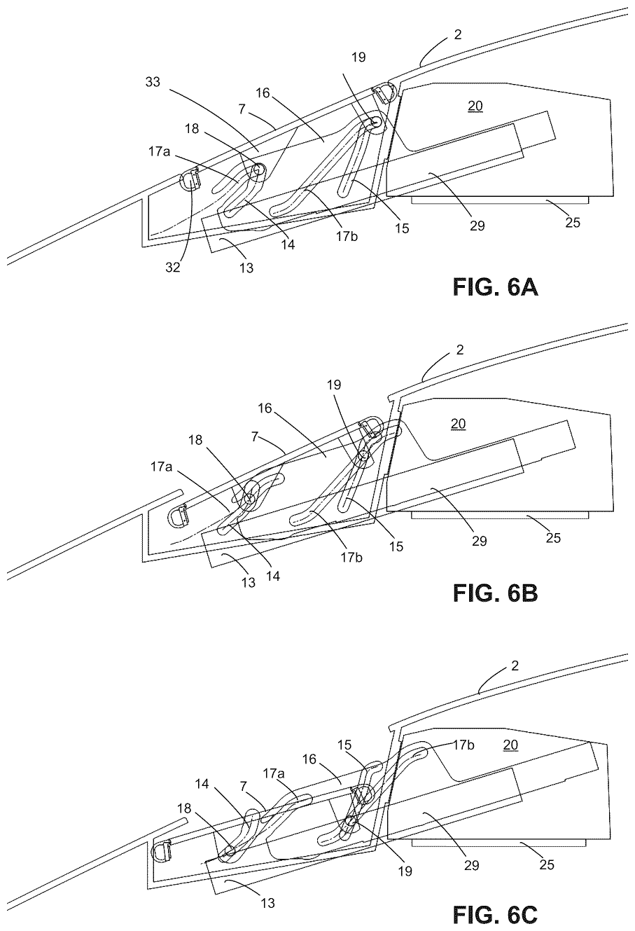

The co-operation of these components will be elucidated with further reference to FIGS. 6A-6C. In FIG. 6A, as in FIG. 5A, the cover panel 7 is in the closed position. The driven slider 16 slider is in an closed position, in this drawing to the left side in the slider channel 29. Rear sliding pin 19 is in a top of the rear locator curve 15 of the guide 13, and simultaneously in a top of the sliding track 17b. While front sliding pin 18 is in a top of the front locator curve 14 of the guide 13.

Operating the driven slider 16 to move rearwardly, to the right in these figures, means that the rear sliding track 17a forces the rear sliding pin19 to move in the rear locator curve 15, downward and to the left in these figures, as can be seen in FIG. 6B. The movement of the driven slider, via the sliding tracks 17a, 17b, thus forces and/or pushes the front and rear sliding pins 18, 19 to travel through the respective front and rear locator curves 14, 15.

In FIG. 6C the cover panel 7 is in the retracted position. The driven slider 16 slider is in a retracted position, in this drawing to the right side in the slider channel 29. Rear sliding pin 19 is near a lower end of the rear locator curve 15 of the guide 13, and simultaneously near a lower end of the rear sliding track 17b. While front sliding pin 18 is near a lower end of the front locator curve 14 of the guide 13, and simultaneously near a lower end of the front sliding track 17a.

From the FIGS. 6A-6C it will be clear that the front locator curve 14 and the rear locator curve 15 are arranged for respectively guiding the front sliding pin 18 and the rear sliding pin 19, while the sliding pins are pushed via the at least one sliding track 17a, 17b.

As will be understood, the motions of the components of the roof module described above may be performed in a reverse order to bring the cover panel back to the closed position.

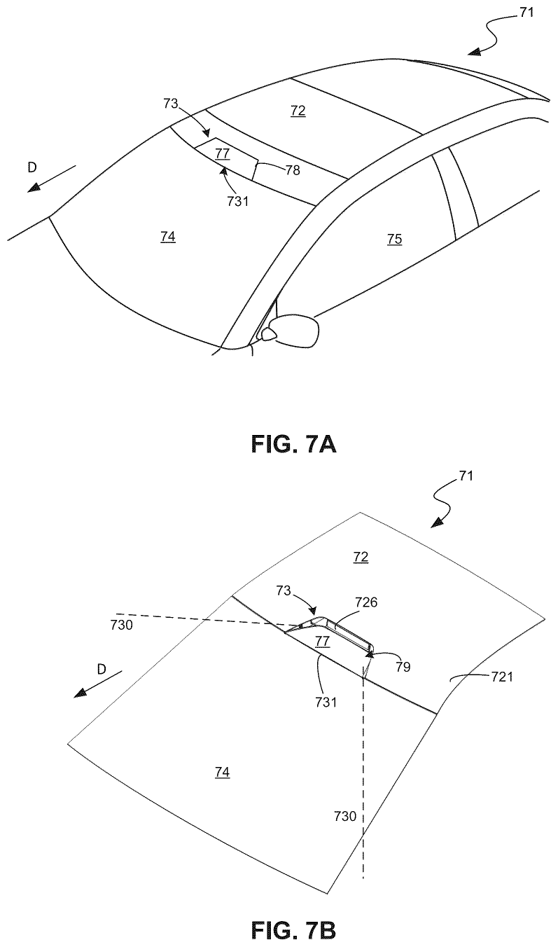

In the embodiments discussed in relation to FIGS. 2-6, the cover panel 7 is intended to be moved forward and underneath the cover panel when placed into the retracted position. Hence, the cover panel will then be located at the interior side of the roof module. However, in other embodiments the cover panel may brought to the exterior side when in the retracted position. In the following embodiments, this will be described in relation to FIGS. 7-9.

Referring to FIGS. 7A and 7B, a perspective view of an example of a vehicle top side 71 is schematically illustrated. The vehicle is oriented with a forward direction of driving as indicated by arrow D. The vehicle top side 71 includes a roof 72. Another embodiment of the vehicle roof module 73 for a sensor is mounted on the roof 72. Further shown are vehicle front window 74 and side windows 75. In contrast to the embodiment illustrated in FIG. 1, a front edge 731 of the roof module 73 is closer and adjacent to the top edge of the front window 74. The roof module 73, just as the roof module 3 of FIG. 4, includes a roof skin 721 having an opening 708. The roof skin 721 again defines the exterior side 22 and the interior side 23 of the roof module 73. The roof module 73 again includes the sensor mounting location 725, arranged at the interior side 23, that includes a visor 726. The visor 726 provides the field of view 730 through the opening 78, as indicated by dotted lines in FIG. 7B. The roof module 73 further includes a cover panel 77 having dimensions that correspond to the opening 78 in the roof skin 721 of the roof panel 72. Also in this embodiment, the opening 78 has an inner perimeter and the cover panel 77 has an outer perimeter corresponding to the inner perimeter of the opening 78. The cover panel 77 is movable between the closed position in FIG. 7A and the retracted position in FIG. 7B. In the closed position shown in FIG. 7A, the cover panel 77 covers i.e. closes off the opening 78 in the roof panel 2 and blocks the field of view 730. In the retracted position shown in FIG. 7B, the cover panel 77 uncovers the opening 78 and clears the field of view 730 of the visor 726. In this embodiment, the cover panel 7 in the retracted position resides above the roof skin 721 and may extend forward slightly over front window 74. In the retracted position, the cover panel 77 uncovers the opening 78 and exposes the inner recess 79 of the roof module 73. Therewith it clears the field of view 730 for a sensor that may be mounted at the sensor mounting location 725, or at least provides a clear field of view through the visor 726 to the exterior side 22. Again, the sensor may be a LiDAR sensor, or any other optical sensor.

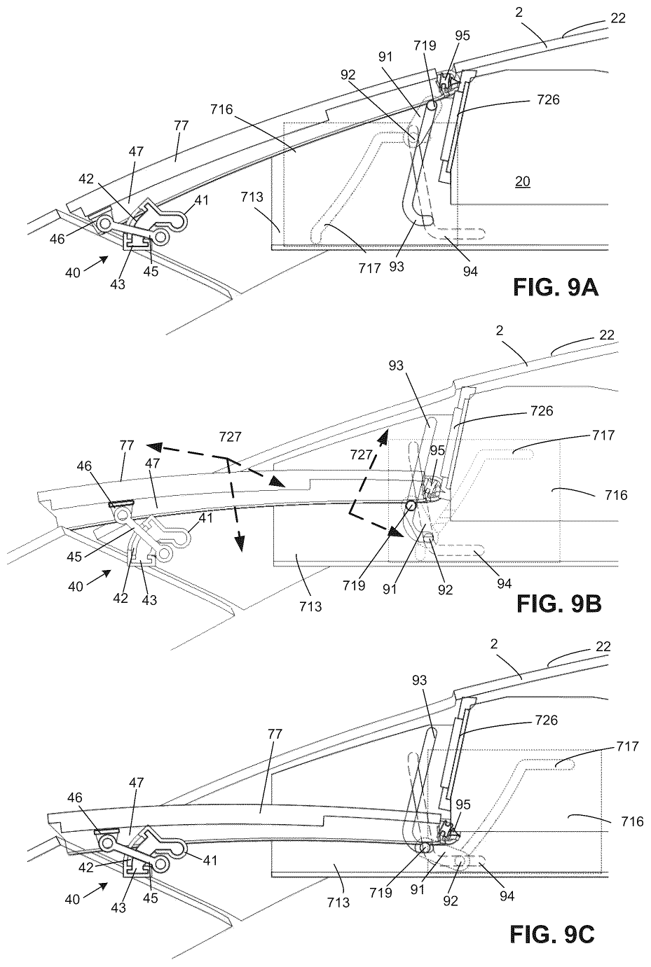

The description referring to FIG. 3 setting out the relation between various components of the roof module 3 equally applies to the roof module 73 embodiment of FIGS. 7A and 7B, with the exception that the cover panel 77 in the retracted position resides above the roof skin 721 of the roof panel 72. Thus, in the closed position, the cover panel 77 may be substantially flush with the roof skin 721. And when moved between the retracted position and the closed position, the cover panel 77 travels along a virtual sliding path 727, as will be explained below with reference to FIGS. 9A-9C.

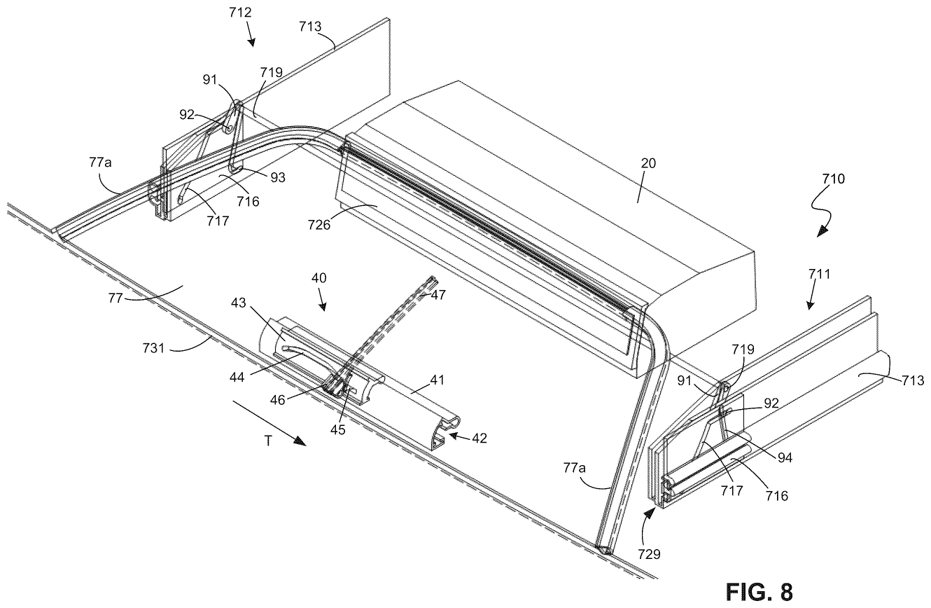

Referring to FIG. 8, illustrating an exploded view of the roof module 73 with the cover panel 77 partially transparent for illustrative purposes, the cover panel 77 is shown to include at each of two respective opposite edges 77a at least one sliding pin respectively. In this embodiment one rear sliding pin 719 on each of the two opposite edges 77a. The roof module 73 again includes the kinematic mechanism 710. The kinematic mechanism 710 consists of two sliding assemblies 711, 712 arranged in parallel at opposing sides of the inner recess 79, which inner recess is adjacent the opening 78. In between the sliding assemblies 711, 712 the cover panel 77 is located, hence the sliding assemblies 711, 712 are spaced apart to accommodate the movement of the cover panel 77 there between. The cover panel 77 faces each sliding assembly 711, 712 with respective side edge 77a. Each sliding assembly 711, 712 consists of a guide 713 having at least one locator curve, in this embodiment, the at least one locator curve includes two rear locator curves 93, 94. Each guide 13 further includes the slider channel 729. Each sliding assembly 711, 712 again includes the driven slider 716 having at least one sliding track 717. The slider channels 729 are for guiding each of the driven sliders 716 parallel to the opposing sides of the recess 79. The cover panel 77 is provided on each side edge 77a facing one respective sliding assembly 711, 712 with the rear sliding pin 719. Two pins at respective opposite edges 77a of the cover panel 77 may be formed by outer portion ends of a single rod. In this example, this is not the case.

In order to have the cover panel 77 move above the roof panel 72, the kinematic mechanism 710 further includes a lifting assembly 40. The lifting assembly 40 including a transverse guide 41 having a second slider channel 42. The lifting assembly 40 further includes a lift slider 43 having a lifting curve 44 and is arranged for sliding along the slider channel 42. The lifting assembly 40 further includes a lift lever 45 having a slide shoe 46 at a tip for movably sliding a rail 47 that is connected to the cover panel 77.

Herein the lift lever 45 is arranged to be lifted upwards and/or downwards by the lifting curve 44 when the lift slider 43 is moved along the slider channel 42 of the transverse guide 41. When moved in direction as indicated by arrow, the lift lever 45 will be lifted up by the lifting curve 44. When moved in opposite direction of arrow T, the lift lever 45 will lifted down. In this manner, the lever 45 may be lifted between a closed, resting position and an opened, raised position. Furthermore, the rail 47 is arranged to move through the slide shoe 46 when the lever 45 is lifted upwards and/or downwards. Accordingly, the single transverse movement of the slider enables an up/down lifting movement. The movement of the slider may be controlled by a single drive cable, which same drive cable may be used to control the driven slider of the sliding assembly. Hence, only a single motor may be required for operating the drive cable, while enabling the elaborate, yet elegant movement of the cover panel.

Though in itself, such an additional lifting assembly as disclosed may be sufficient to provide a desired sliding path for bringing the cover panel in the retracted position that is exterior of the roof module, the sliding assembly as described thus far may be further expanded.

Thereto, each sliding assembly 711, 712 of the kinematic mechanism 710 further includes a pulling lever 91. The pulling lever 91 includes at one end at least one pulling pin 92 and at another end is connected to at least one the sliding pin 719 of the cover panel 77. In this embodiment, the at least one locator curve 93, 94 and the at least one sliding track 717 are further arranged for guiding the respective at least one sliding pin 719 and the pulling pin 92, such that the cover panel 77 moves along the sliding path 727. More in particular, in this embodiment, a front portion of the cover panel travels along a first portion of the sliding path 727, and a rear portion of the cover panel travels along a second portion of the sliding path 727. When the cover panel 77 is moving from the closed position to the retracted position, the first portion of the sliding path runs upwards and forwards, while the second portion runs substantially downwards, whereafter the whole cover panel moves rearwards.

The co-operation of the components making up the kinematic mechanism of the embodiment of FIGS. 7-8 will be elucidated with further reference to FIGS. 9A-9C. In FIG. 9A, the cover panel 77 is in the closed position.

In FIG. 9A, the lifting assembly 40 is in a closed position wherein it rests at one end of the lifting curve 44. The driven slider 716 is in the closed position, in this drawing to the left side in the slider channel 729. Rear sliding pin 719 is in a top of the rear locator curve 93 of the guide 713. The pulling pin 92 is in a top of a pulling locator curve 94 and simultaneously in a top of the sliding track 717. The top of the pulling locator curve 94 is lower than the top of the rear locator curve 93. This allows to have the pulling pin lead the rear sliding pin via the pulling lever.

By moving the lift slider 43 in the direction T, as indicated in FIG. 8, the lift lever 45 is raised and a front edge or portion of the cover panel 77 is raised as the slide shoe 46 travels along rail 47, as seen in FIG. 9B. Subsequently, or simultaneously, depending on the chosen configuration, the driven slider 716 may be operated to move rearwardly, to the right in these figures, enabling the sliding track 717 to force the pulling pin 92 to move in the pulling locator curve 94. In turn, the pulling pin 92 respectively pulls via the puling lever 91 the thereto connected sliding pin 719 downward through the rear locator curve 93. The movement of the driven slider 716, via the sliding track 717, thus forces and/or pushes the pulling pin 92 and the sliding pin 719 to travel through the respective pulling locator curve 94 and the rear locator curve 93.

With the lift lever 45 in the raised position, the front edge of the cover panel 77 may stick out and extend over the roof panel 2. As this may result in drag or wind noise, the extent to which the front edge sticks out, the cover panel may be pulled in rear ward direction by moving the pulling pin further through the pulling locator curve 94. Accordingly, in FIG. 9C the cover panel 77 is in the retracted position. The driven slider 716 slider is in the retracted position, in this drawing to the right side in the slider channel 729. Rear sliding pin 719 is near a lower part of the rear locator curve 715 of the guide 713. The pulling pin 92 is in a lower end portion of the pulling locator curve 94 and simultaneously near a lower portion of the sliding track 717. The lower end portion of the pulling locator curve 94 is lower than the lower part of the rear locator curve 93. The movement of This allows to have the pulling pin pull the cover panel rearward via the pulling lever.

From the FIGS. 9A-9C it will be clear that the rear locator curve 93 and the pulling locator curve 94 are arranged for respectively guiding the rear sliding pin 719 and the pulling pin 92, while the pulling pin is pushed via the at least one sliding track 717. The arrangement of these curves is such that when the front portion of the cover panel is raised, the cover panel is lowered and pulled rearward.

As will be understood, the motions of the components of the roof module described above may be performed in a reverse order to bring the cover panel back to the closed position.

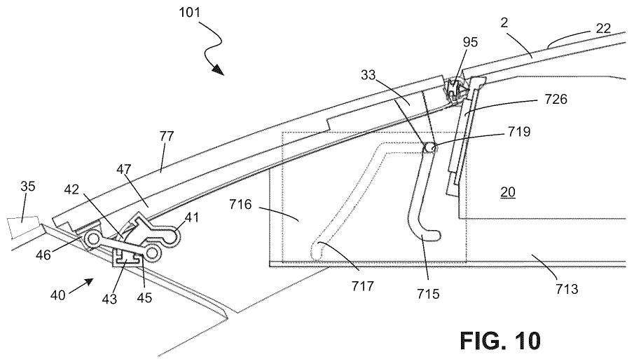

As may be understood, the pulling lever, pulling pin, and pulling locator curve may be dispensed with to obtain a configuration having less components. Such an embodiment is illustrated in FIG. 10. Herein, elements corresponding to those of FIGS. 9A-9C have the same references. The roof module 101 is mounted on the roof 2, and includes cover panel 77. A sensor 20 is provided within the roof module 101. The roof module further includes lifting assembly 40, similar to that of FIG. 8. The roof module includes a sliding assembly 1011 different from that of FIG. 8, as the pulling lever and associated components are dispensed with. Accordingly, the movement of the front portion of the cover panel is similar to that as explained in relation to FIGS. 9A-9C. The movement of the rear portion of the cover panel is similar to that as explained in relation to FIG. 6A-6C. Whereas the rearward pulling motion of the whole cover panel is of FIGS. 9A-9C is absent, or at least less articulated.

In order to provide means for cooling, the inner recess may include openings adjacent the visor that allow air to move into the interior of the module towards the sensor. These cooling openings further separate the sensor mounting frame from the inner recess. When the cover panel in the closed position it may cover the cooling openings. This as to preserve an aesthetic appearance when the sensor is not in operation. Cooling openings in the shape of slits, circles, ellipses or other suitable shape may be provided. For example in the embodiment of FIG. 4, the roof module is further provided with cooling openings or vents 34, which further separate the sensor mounting frame from the inner recess 9. The cooling openings 34 are provided such that the cover panel 7 in the covering position, covers the cooling openings 34 from the exterior side. When the cover panel is in the retracted position and a sensor mounted in the roof module is operating, these vents or openings provide additional means for convection of heat potentially coming from operation of the sensor and control unit thereof.

In another embodiment, the cover panel may provide for a wiping function. Thereto, the cover panel 7 may include a wiper blade 95 adjacent one edge 7b of the cover panel 7 facing the visor 26. This may allow the kinematic mechanism to be arranged such that the wiper blade is able to wipe the visor when the cover panel is being moved along the sliding path. In another embodiment, the cover panel 7 may be provided with means to bring the wiper blade in a position that engages the wiper and a position disengaging from the visor. This allows to control the wiping action and activate wiping functionality only if and/or when desired. Again referring to FIGS. 9A-9C, the cover panel 77 further includes the wiper blade 95, which is adjacent one edge 7b facing the visor 26. The locator curves are arranged such that when the cover panel moves along a portion of the sliding path 727, the wiper blade 95 may engage the visor 26 and perform a cleaning action. Also in the embodiment of FIG. 10, the cover panel 77 is provided with the wiper blade 95.

In addition to the wiper blade, or alternatively, the cover panel 7 may be provided with one or more cleaning nozzles. Which, when activated, allows the visor to be sprayed with a fluid, such as air or water, to enable cleaning of the visor. Alternatively, one or more cleaning nozzles may be provided within the recess and operated when the cover panel is in the retraced position. For example in FIG. 10, a nozzle 35 is positioned on the roof module. Without regard to the type and placement of nozzles, whether on or underneath the cover panel, it is preferred that such nozzles are mainly operated when the cover panel is in the retracted position, as this may allow headwind as e.g. during vehicle movement, to aid in dispersing fluid from the visor.

With the various examples of kinematic mechanisms as described above, it is also possible to have the cover panel in various positions along the virtual sliding path.

Accordingly, the cover panel 7 of FIG. 3 and the cover panel 77 of FIG. 10 may be movable into at least one intermediate position, the at least one intermediate position being along the respective sliding path 27, 727 between the retracted position and the closed position. And when in the at least one intermediate position, the position of the cover panel preferably maintains, at least partially, the field of view for the visor 26. Hence, the intermediate position of the cover panel is such that a sensor placed in the sensor mounting location 25 will preserve sight of the exterior surroundings.

Depending on the speed of the vehicle, the slant of the front window and other circumstances, the position of the cover panel may be manipulated to reduce e.g. wind noise, or it may be manipulated to improve drying of the visor through air flow, for example after a cleaning action or in case of rain. In order to detect such operational circumstances, the roof module may be further equipped with a control unit and a NVH detection unit or similar means for detection of Noise, Vibration, and/or Harshness. The NVH detection means may generate a signal indicative of a NVH parameter. The control unit is configured for moving the cover panel, in response to the NVH parameter exceeding a predetermined threshold, into one of the at least one intermediate position to reduce the NVH parameter. The NVH detection unit/means may include an acoustic sensor; and/or a vibration sensor; and/or an air flow sensor, such as a mass air flow sensor. Such a control unit may be part of the sensor that is to be mounted in the roof module.

Although the present invention has been described above with reference to specific embodiments, it is not intended to be limited to the specific form set forth herein. Rather, the invention is limited only by the accompanying claims and, other embodiments than the specific above are equally possible within the scope of these appended claims.

Furthermore, although exemplary embodiments have been described above in some exemplary combination of components and/or functions, it should be appreciated that, alternative embodiments may be provided by different combinations of members and/or functions without departing from the scope of the present disclosure. In addition, it is specifically contemplated that a particular feature described, either individually or as part of an embodiment, can be combined with other individually described features, or parts of other embodiments.

What is claimed is:

1. A vehicle roof module for a sensor, configured to be mounted on a roof of a vehicle, the roof module comprising:
a roof skin having an opening and defining an exterior side and an interior side of the roof module;
a sensor mounting location, arranged at the interior side, comprising a visor providing a field of view through the opening;
a cover panel movable along a sliding path;
a kinematic mechanism for moving the cover panel along the sliding path between:
a closed position wherein the cover panel covers the opening and blocks the field of view of the visor; and
a retracted position wherein the cover panel uncovers the opening and clears the field of view of the visor.

2. The vehicle roof module according to claim 1, wherein the opening has an inner perimeter and the cover panel has an outer perimeter corresponding to the inner perimeter of the opening; and
wherein the cover panel in the closed position is substantially flush with the roof skin.

3. The vehicle roof module according to claim 1, wherein
the cover panel comprises at each of two opposite edges at least one respective sliding pin;
the kinematic mechanism comprises two sliding assemblies arranged in parallel at opposing sides of an inner recess adjacent the opening on the interior side, each sliding assembly comprising:
a driven slider having at least one sliding track;
a guide having at least one locator curve and a slider channel for guiding the driven slider parallel to the opposing sides of the inner recess; and
wherein the at least one locator curve and the at least one sliding track are arranged for guiding the respective at least one sliding pin, such that the cover panel moves along the sliding path.

4. The vehicle roof module according to claim 3,
wherein the at least one sliding pin comprises a front sliding pin and a rear sliding pin;
wherein the at least one locator curve comprises a front locator curve and a rear locator curve; and
wherein the front locator curve and the rear locator curve are arranged for guiding respectively the front sliding pin and the rear sliding pin.

5. The vehicle roof module according to claim 3,
wherein the at least one sliding track comprises a front sliding track and a rear sliding track; and
wherein the front sliding track and the rear sliding track are arranged for guiding respectively the front sliding pin and the rear sliding pin.

6. The vehicle roof module according to claim 3, wherein two sliding pins at respective opposite edges of the cover panel are formed by outer portion ends of a single rod.

7. The vehicle roof module according to claim 1, wherein the cover panel in the retracted position is located either at the interior side or at the exterior side.

8. The vehicle roof module according to claim 1, wherein the kinematic mechanism further comprises a lifting assembly, the lifting assembly comprising:
a transverse guide comprising a second slider channel;
a slider having a lifting curve, the slider arranged for sliding along the second slider channel;
a lift lever comprising a slide shoe for movably sliding a rail connected to the cover panel;
wherein the lift lever is arranged to be lifted upwards and/or downwards by the lifting curve when the slider is moved along the second slider channel of the transverse guide; and
wherein the rail is arranged to move through the slide shoe when the lift lever is lifted upwards and/or downwards.

9. The vehicle roof module according to claim 3, wherein each sliding assembly further comprises a pulling lever and a pulling locator curve;
wherein the pulling lever comprises at one end at least one pulling pin and at another end is connected to at least one sliding pin of the cover panel; and
wherein the at least one locator curve, the pulling locator curve and the at least one sliding track are further arranged for guiding the respective at least one sliding pin and the pulling pin, such that the cover panel moves along the sliding path.

10. The vehicle roof module according to claim 1, wherein the cover panel further comprises a wiper blade adjacent one edge facing the visor.

11. The vehicle roof module according to claim 3, further comprising cooling openings further separating the sensor mounting location from the inner recess; and
wherein the cover panel in the closed position, covers the cooling openings.

12. The vehicle roof module according to claim 1, wherein the cover panel is movable into at least one intermediate position, the at least one intermediate position being along the sliding path between the retracted position and the closed position; and
wherein the at least one intermediate position maintains, at least partially, the field of view for the visor.

13. The vehicle roof module according to claim 12 further comprising:
at least one nozzle mounted on the cover panel such that in one of the at least one intermediate position, the nozzle is aimed/directed at the visor; and
wherein moving the cover panel along the sliding path in and out of one of the at least one intermediate position aims/directs the nozzle at different areas of the visor.

14. The vehicle roof module according to claim 12, further comprising:
a control unit;
wherein the control unit is arranged for receiving a contamination signal indicative of contamination being present on the visor; and
wherein the control unit is further arranged for moving the cover panel, in response to receiving the contamination signal, into one of the at least one intermediate position to reduce contamination on the visor.

15. The vehicle roof module according to claim 12, further comprising:
NVH detection unit/means for detection of Noise, Vibration, and/or Harshness, the NVH detection means generating a signal indicative of a NVH parameter; and
a control unit;
wherein the control unit is configured for moving the cover panel, in response to the NVH parameter exceeding a predetermined threshold, into one of the at least one intermediate position to reduce the NVH parameter; and
wherein the NVH detection unit/means comprises:
an acoustic sensor; and/or
a vibration sensor; and/or
an air flow sensor, such as a mass air flow sensor.
